(19) United States
(12) Patent Application Publication
(10) Pub. No.: US 2016/0173326 A1
(43) Pub. Date: Jun. 16, 2016

(54) NETWORK CONFIGURATION USING SERVICE IDENTIFIER

(71) Applicant: HEWLETT PACKARD DEVELOPMENT COMPANY, L.P., Houston, TX (US)

(72) Inventor: Yannick KOEHLER, Québec (CA)

(21) Appl. No.: 14/907,677

(22) PCT Filed: Jul. 26, 2013
(86) PCT No.: PCT/US2013/052291

§ 371 Date: Jan. 26, 2016

(51) Int. Cl. H04L 12/24; H04L 29/12; H04L 12/26; H04L 29/08

(52) U.S. Cl. CPC H04L 41/0803; H04L 41/5045; H04L 41/0853; H04L 67/16; H04L 61/1541; H04L 43/0805

(57) ABSTRACT

A network controller may include a monitor and a configuration handler. The monitor may determine a service address and a service identifier. The configuration handler may use the service identifier to obtain a configuration for the service address. The configuration handler may also provide the configuration to a network node.

### BACKGROUND

A network service may be provided by a server to a client over a network. Examples of network services include web services, email, directory services, voice over Internet Protocol (VoIP), instant messaging, streaming media, file transfer, and network printing.

### BRIEF DESCRIPTION OF THE DRAWINGS

Certain examples are described in the following detailed description and in reference to the drawings, in which:

FIG. 1 illustrates an example network controller including a monitor and a configuration handler;

FIG. 2 illustrates an example network controller including a monitor, a configuration handler, a management interface, and a service discoverer;

FIG. 3 illustrates an example network controller including a processor and a non-transitory computer readable medium to implement a monitor and a configuration handler;

FIG. 4 illustrates an example method of providing a configuration to a network node; and

FIG. 5 illustrates an example method of obtaining service configurations.

### DETAILED DESCRIPTION OF SPECIFIC EXAMPLES

Networking nodes, such as routers, bridges, and switches, may be configured with service-specific settings related to how network nodes handle packets associated with a service. These configurations may be based on a service address that references an endpoint location of a service. For example, a service address may be a socket address—a combination of Internet Protocol (IP) address of a server, and transport protocol and port used for the service. For example, network nodes may be configured to provide particular firewall settings, quality of service (QoS) settings, or network address translation (NAT) static port mappings based on packet destination address fields. As an example, a network host may be connected to a switch and may be a client of a file server and a client of a VoIP service. The network administrator may configure the switch to provide a higher QoS to the packet flow with the VoIP service than the packet flow with the web service. This may occur by setting the switch to apply a higher QoS to packets identified by the IP address, protocol, and port number of the VoIP service and to apply a lower QoS to packets identified by the IP address, protocol, and port number of the file service.

In a network, services may become available, become unavailable, or change location. As networks grow in size or complexity and as mobility increases, it may be difficult for a network administrator to configure the service related settings of network nodes based on the service address, especially when this address may change when a service changes location on a network. For example, a service may change location by changing IP address or port number. For example, a printer service might change its IP address if it is moved from one network connector to another.

Some protocols, such as Universal Plug and Play (UPnP), may allow a client to automatically configure the settings of a network node. However, in many network environments, a client may not be trustworthy to set the configuration of a network node and a network administrator may prefer to set the configuration of the network node.

Some implementations of the disclosed technology may allow service-based network node configuration to be managed by a network administrator using service identifiers. Service-related configuration settings, such as a NAT static mapping, firewall settings, or QoS setting, may be applied in a non-static manner and maintained if the service changes address. For example, a network monitor may monitor service address resolution requests or responses to determine when a service changes address. A configuration handler may determine a configuration for the service based on the new service address. Accordingly, a service-related configuration may be maintained when a service moves from one port or network address to another.

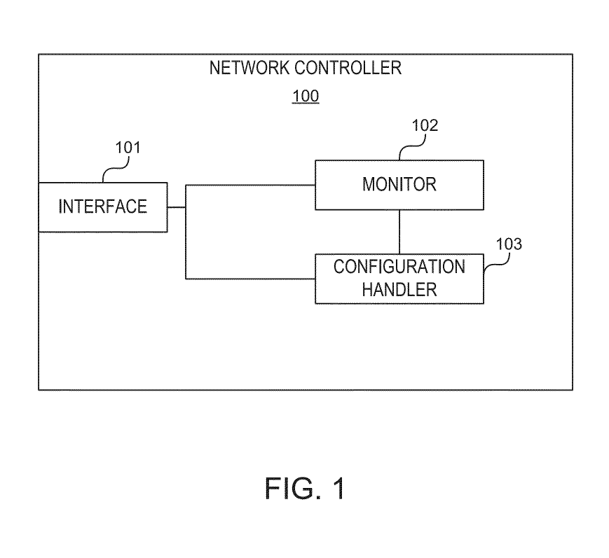

FIG. 1 illustrates an example network controller 100 including a monitor 102 and a configuration handler 103. In some implementations, the example network controller 100 may be an access point controller controlling a wireless access point. In further implementations, the example network controller 100 may be a software-defined networking (SDN) controller controlling a SDN switch, such as a bridge or router. In various implementations, the illustrated modules, such as the monitor 102 and configuration handler 103, may be provided jointly or separately in hardware or in software stored on non-transitory computer readable media.

The example network controller 100 also includes a network interface 101 to allow the network controller 100 to connect to a network. The network may include the client and a server connected by a path including one or more network nodes, such as routers, bridges, or switches. In some implementations, the network and connected devices may be physical, virtual, or a combination thereof.

In the illustrated example, the monitor 102 may monitor a service address resolution message exchange to determine a service address and a service identifier. In some implementations, the service address may be a reference usable by a network device to identify a network endpoint. For example, the service address may be a service's network socket address, including the service's IP address, protocol, and port number. In some implementations, the service identifier may include a service instance. For example, a service identifier for a printer, Example Printer, might include Example Printer._printer._tcp._local. In further implementations, the service identifier may include a portion of a service instance. For example, a service identifier for Example Printer might also include c, where * denotes a wildcard. In these cases, the service identifier may identify multiple services. For example, *._printer._tcp._local might identify any printer on a local network, including Example Printer.

In some implementations, the monitor 102 may use the interface 101 to listen to service address resolution requests from clients and service address resolution responses from service providing servers or domain name servers. The monitor 102 may obtain the service identifier from the service address resolution request and may obtain the service address from the service address resolution response. As another example, the monitor 102 may use the interface 101 to listen to service address resolution responses from servers. These service address responses may include both the service identifier and the service address.

In some implementations, the client and the server may use a zero-configuration networking (zeroconf) protocol to conduct a service address resolution message exchange. The service address resolution messages may include service address resolution requests sent by a client to obtain a service address for a service instance. The service address resolution messages may also include service address resolution responses, which include the service address for the service instance and are sent to the client by the service providing server or another domain name server. In some implementations, the service address resolution responses may be secured using various security extensions to network protocols. For example, if a Domain Name Service (DNS) reply serves as a service address resolution response, DNS Security Extensions (DNSSEC) may be used to authenticate the response. As another example, if a multicast Domain Name Service (mDNS) reply serves as a service address resolution response, a DNSSEC may be used to authenticate the response and a client may certify the mDNS response with the server providing the service.

In one example, the client and the server may use a BONJOUR as a zeroconf protocol. In this example, a service address resolution request may be a mDNS query message including a service instance. A service address resolution response may be an mDNS response including a service (SRV) record including a domain name and port. Another service address resolution request may be an mDNS query message including the domain name. Another service address resolution response may be an mDNS response including an Internet Protocol (IP) address. In an implementation, the monitor 102 may monitor the first mDNS query message to determine the service instance value as the service identifier. In this example, the monitor 102 may monitor the first mDNS response message to determine a port that the client will use for the service. Further, the monitor 102 may monitor the second mDNS response message to determine an IP address that the client will use for the service. The monitor 102 may use the port and IP address as the service address. In another implementation, the port may be implied by the service identifier and the monitor 102 may use the second mDNS response to determine the IP address as the service address.

In other examples, the client and server may use other zeroconf protocols, such as a Simple Service Discovery Protocol (SSDP) or a Service Location Protocol (SLP). In these examples, the monitor 102 may monitor the service address resolution message exchanges implemented in these protocols to determine the service identifier and service address. For example, in a network employing a SSDP zeroconf protocol, the service address resolution messages may include M-SEARCH request messages as service address resolution requests and M-SEARCH response messages as service address resolution responses. As another example, in a network employing a SLP zeroconf protocol, the service address resolution messages may include service requests and service replies.

In further examples, the monitor 102 may perform deep packet inspection on packets exchanged by a client and a server during an ongoing service. For example, the monitor 102 may inspect the payloads of packets exchanged by the client and server and match the payloads against payload patterns corresponding to various service identifiers. The monitor 102 may use the results of the deep packet inspection to determine the service identifier and service address. For example, by matching the payloads to the payload patterns, the monitor 102 may determine a service identifier. By monitoring the packets' source or destination address, the monitor 102 may determine a service address corresponding to the service identifier. As an example, the monitor 102 may use deep packet inspection to distinguish between services having a common service instance. For example, a web server may provide two different Hypertext Transfer Protocol (HTTP) based services with both having a common service instance, such as webserver._http._tcp.exampledomain.com.

The example network controller 100 further includes a configuration handler 103. The configuration handler 103 may obtain the service identifier and the service address from the monitor 102. In some implementations, the configuration handler 103 may use the service identifier to obtain a configuration for the service address and to provide the configuration to a network node connected to the client. For example, the configuration handler 103 may use the service identifier to perform a database lookup to identifier a configuration database entry for the service identifier. The configuration handler 103 may use the configuration entry to generate a configuration for the service address. For example, the configuration for the service address may be a configuration file associating the service address with configuration settings, such as QoS values, NAT port mappings, firewall settings. Accordingly, the configuration handler 103 may allow configurations to be managed based on service identifiers and to ensure that those configurations are applied as needed and in an address-independent matter. In some implementations, for previously configured network nodes, the configuration handler 103 only obtains and provides the configuration if the service address changes.

As an example, the configuration handler 103 may configure network nodes such that any VoIP packets have a particular QoS. In this example, the configuration handler 103 may use the service identifier to determine that the client is using a VoIP service. The configuration handler 103 may then generate a configuration establishing the QoS for packets addressed to the VoIP service's IP address and port number. As another example, the configuration handler 103 may cause a particular VoIP instance's packets to have a particular QoS. In this example, the configuration handler 103 may use the service identifier to determine that the client is using the particular VoIP instance. The configuration handler 103 may then determine the appropriate QoS configuration for the VoIP service's address.

The configuration handler 103 may provide the configuration to a network node connected to the client. In different implementations, the configuration handler 103 may provide the configuration to the network node in various manners. For example, the configuration handler 103 may use the interface 101 to provide the configuration to the network node in-band. For example, if the example controller 100 is an access point controller, the configuration handler 103 may provide the configuration to an access point using a predefined configuration protocol. For example, the configuration handler 103 may provide the configuration as an instruction set using a predefined syntax for configuring an access point over interface 101. As another example, the configuration handler 103 may use another interface to provide the configuration out-of-band. For example, if the example controller 100 is an SDN controller, the configuration handler 103 may provide the configuration as a flow control rule including matching criteria matching the service address and an action defined to implement the configuration settings. For example, to implement a NAT port mapping, the rule may have a match criteria matching the service address and an output port action that implements the NAT port mapping.

In some implementations, the configuration may be provided to a network node directly connected to the client. In further implementations, the configuration may be provided to a network node connected to the client via intermediary network nodes. For example, the configuration handler 103 may provide the configuration to a bridge directly connected to the client and may provide the configuration to a router connected to the bridge. In further implementations, the configuration handler 103 may use the service identifier to determine different configurations for different network nodes on the path from the client to the server. For example, the configuration handler 103 may determine a firewall setting and a first QoS setting for a bridge directly connected to the client and a second QoS setting for a router connected to the bridge.

In further implementations, the monitor 102 may detect the service being unavailable. For example, the monitor 102 may obtain a time-to-live value from a packet provided by the service during service discovery. The monitor 102 may determine the service being unavailable if the time to live expires. The monitor 102 may provide an indication of expired services to the configuration handler 103. The configuration handler 103 may cause a configured network node to remove the configuration if the service becomes unavailable. For example, the configuration handler 103 may transmit an instruction to any network nodes that were configured to remove their configuration. This may free up resources on the previously configured network nodes.

In some cases, a service may have multiple service addresses. For example, the service may be associated with multiple IP addresses. In some implementations, in these cases, the monitor 102 may determine each of service addresses and provide the service addresses to the configuration handler 103. The configuration handler 103 may generate a configuration for each of the service addresses and provide each configuration to the network node. In other implementations, the monitor 102 may listen to a service packet from the client to determine which service address the client chose. For example, if a client is provided multiple service addresses for a web site, the monitor 102 may inspect the destination address of future packets from the client to determine which service address the client used to connect to the web site. The monitor 102 may then provide the chosen service address to the configuration handler 103. The configuration handler 103 may generate a configuration for the chosen address and provide the configuration to the network node.

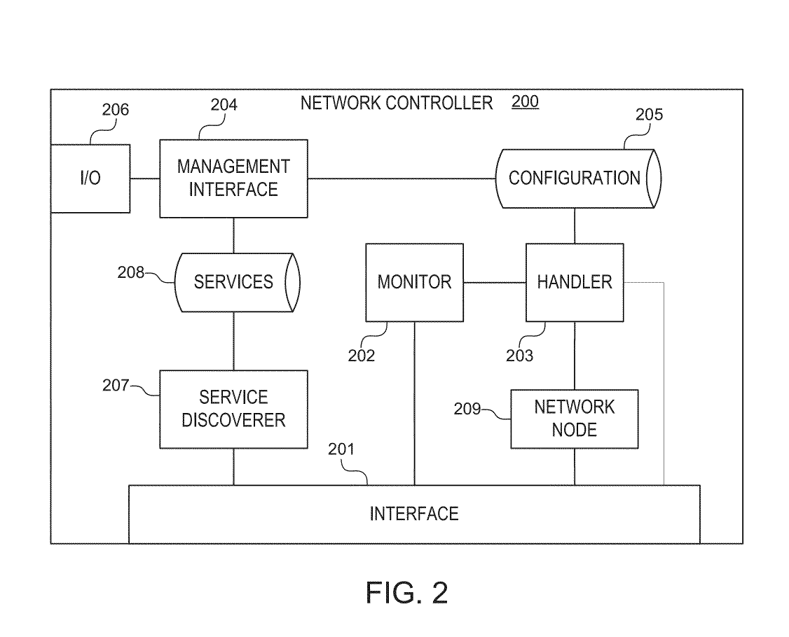

FIG. 2 illustrates an example network controller 200 including a monitor 202, a configuration handler 203, a management interface 204, and a service discoverer 207. In various implementations, the illustrated modules may be provided jointly or separately in hardware or in software stored on non-transitory computer readable media.

The example network controller 200 includes a management interface 204. The management interface 204 may obtain a configuration associated with a service identifier and may provide the configuration to the configuration handler 203. For example, the management interface 204 may store the obtained configuration in a configuration database 205 that is accessible by the configuration handler 203. In some implementations, entries in the configuration database 205 may include configuration information associated with a service identifier. Table 1 illustrates example entries of a configuration database 205.

TABLE 1

| Service Identifier | Configuration Information |
|---|---|
| Conference1._voip._tcp.local | QoS Level 1 |
| *._voip._tcp.local | QoS Level 2 |

In Table 1, a first example service identifier of a VoIP instance located in a conference room, conference1._voip._tcp.local, is associated with configuration information providing a first level of QoS. Further, a second example service identifier matching any local VoIP service, *._voip._tcp.local, is associated with configuration information providing a second level of QoS.

In some implementations, the management interface 204 may obtain the configuration prior to the associated service becoming available. For example, the management interface 203 may be connected to an input/output (I/O) 206, such as a keyboard, mouse, and monitor, or a network interface, to allow the management interface 204 to receive the configuration from a network administrator. This may allow the network administrator to pre-configure the network prior to services joining the network.

For example, a network administrator may wish to provide configurations for VoIP QoS to the management interface 204. In this example, the network administrator may provide a default configuration having a default QoS value associated with a VoIP service name. Additionally, the network administrator may wish for a specific instance of the VoIP service, such as an instance located in a conference room, to have a higher-than-default QoS value. In this case, the network administrator may provide an instance-specific configuration having a higher QoS value. For example, Table 1 illustrates examples of a configuration where an VoIP instance in a conference room is given a higher QoS value than a default value for local VoIP services. In further implementations, a network administrator may provide configurations associated with other service identifiers. For example, the service identifier may be a top-level domain, a subdomain, or a host name. For example, a network administrator may provide a configuration to the management interface 204 so that services on example1.com have different firewall settings than services on example2.local.

In some implementations, the network controller 200 further includes a service discoverer 207. The service discoverer 207 may discover a service identifier. The service discoverer 207 may provide the service identifier to the management interface 204. For example, the service discoverer 207 may store the service identifier in a database 208. In some implementations, the service discoverer 207 may be a module that discovers a service instance value for services available on the network. For example, the service discoverer 207 may include an mDNS responder daemon connected to the network by a network interface 201. The service discoverer 207 may discover a service when a server publishes the service or when a device on the network queries for a service.

In an example including a service discoverer 207, the management interface 204 may present a network administrator with a discovered service. For example, the management interface 204 may provide the contents of the services list 208 to the network administrator using the I/O 206. Additionally, the management interface 204 may provide a program interface allowing a network administrator to provide configuration for the services. For example, the management interface 204 may allow the administrator to input a specific configuration for a newly discovered service instance or a more general configuration for a service identifier encompassing the newly discovered service identifier.

In further examples, the management interface 204 may compare the service list 208 with the configuration database 205. The management interface 204 may provide an alert using the I/O 206 if there is a service instance in the service list 208 that does not have a corresponding entry in the configuration database 205. For example, if a new file sharing device, Example Device, publishes example-device._ftp._tcp.local., the management interface 204 may alert the administrator using the I/O 206. Until a configuration for this specific instance is provided, the configuration handler may use a default configuration for file services, such as a configuration for *._ftp._tcp.local., where * denotes a wildcard.

In some implementations, the network controller 200 may include an integrated network node 209, such as a router. In these implementations, the handler 203 may provide configurations to the integrated network node 209 as well as to external network nodes.

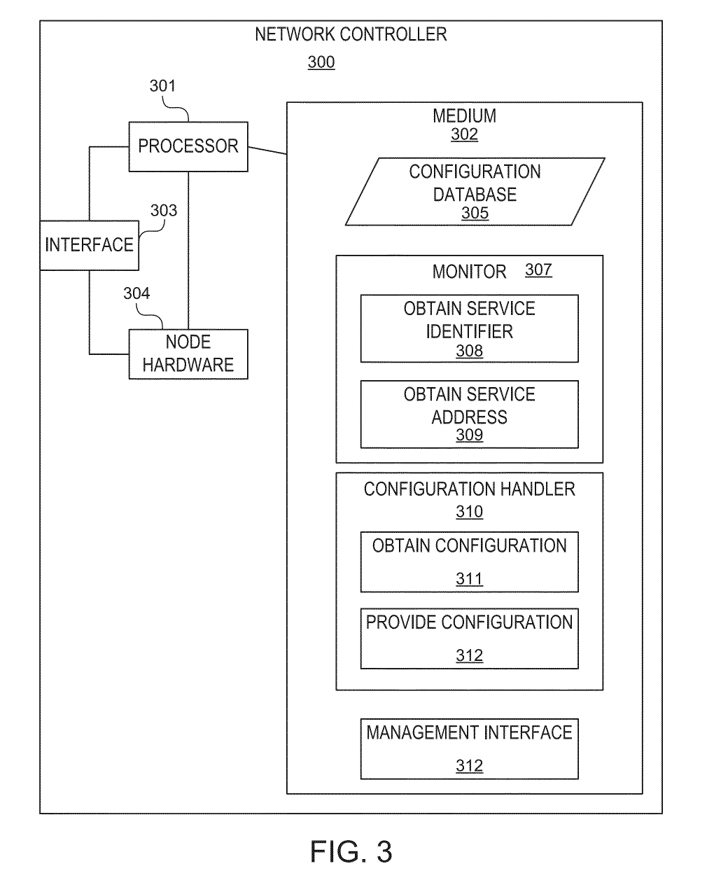

FIG. 3 illustrates an example network controller 300 including a processor 301 and a non-transitory computer readable medium 302 storing instructions 307 to implement a monitor and instructions 310 to implement a configuration handler. For example, when the instructions stored on medium 302 are executed by the processor 301, the example network controller 300 may operate as described above with respect to FIG. 1 or FIG. 2. In some implementations, the non-transitory computer readable medium 302 may include read-only memory (ROM), random-access memory (RAM), storage, or combinations thereof. In further implementations, the non-transitory computer readable medium 302 may include a memory or storage storing the instructions prior to loading the instructions onto the network controller 300.

The monitor instructions 307 may include instructions 308 to implement the monitor by obtaining a service identifier. For example, when executing instructions 308, the processor 301 may obtain the service identifier from a service address resolution request obtained using a network interface 303.

The monitor instructions 307 may further include instructions 309 to implement the monitor by obtaining the service address. For example, when executing instructions 309, the processor 301 may obtain the service address from a service address resolution response obtained via the network interface 303.

The handler instructions 310 may include instructions 311 to implement the configuration handler by obtaining a configuration for a network node using the service identifier. For example, the medium 302 may store a configuration database 305 and the instructions 311 may cause the processor 301 to obtain the configuration from the configuration database 305. The configuration database 305 configurations associated with service identifiers as database entries. For example, the configuration database 305 may have configurations associated with service instances, service names, domain names, protocol types, or port numbers. The database entries may include wildcards. In these cases, the instructions 311 may cause the processor 301 to match the service identifier with a configuration database entry having a wildcard. For example, a service may have an instance value, example._VoIP._tcp.local, and the configuration database 305 may have an entry associating a QoS setting with *._VoIP._tcp.local, where * denotes a wildcard. In this example, the processor 301 may obtain the configuration by matching example._VoIP._tcp.local with *._VoIP._tcp.local.

The instructions 311 may also cause the processor 301 to generate a configuration for the service address using the configuration associated with the service identifier. For example, the configuration may be associated with an IP address and port number obtained as the service address.

The handler instructions 310 may include instructions 312 to implement the configuration handler by providing the configuration to a network node. For example, the processor 301 may use the interface 303 to provide the configuration to the network node. As another example, the network controller 300 may act as a network node. For example, the controller 300 may include node hardware 304, such as routing or bridging application specific integrated circuits (ASICs) and ternary content addressable memory (TCAM) tables. The processor 301 may execute instructions 312 by configuring the node hardware 304 according to the configuration.

In further implementations, the medium 302 may store instructions 312 that cause the processor 301 to implement a management interface. The management interface instructions 312 may cause the processor 301 to obtain the configuration and add the configuration to the configuration database 305. For example, the processor 301 may implement the management interface to provide an interface to receive configurations from a network administrator. When executing the management interface instructions 312, the processor 301 may also present a list of discovered services to the network administrator.

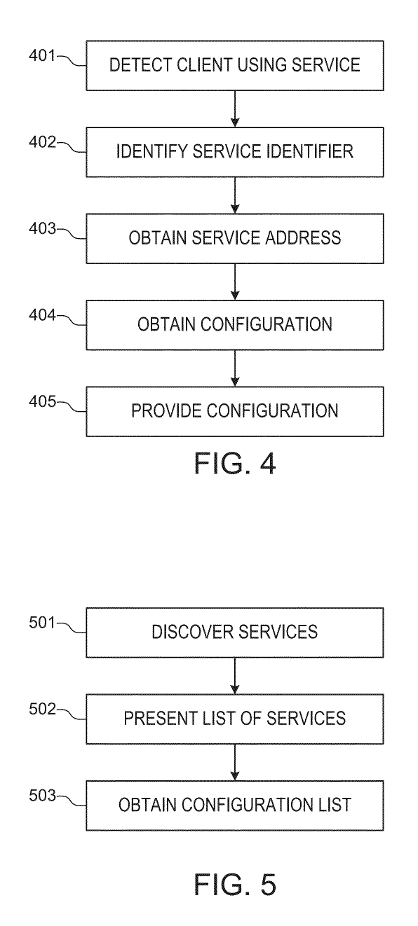

FIG. 4 illustrates an example method of providing a configuration to a network node. For example, the illustrated method may be performed by a network controller, such as the example network controller 100 of FIG. 1, the example network controller 200 of FIG. 2, or the example network controller 300 of FIG. 3.

The example method includes detecting a client using a service 401. In some implementations, detecting the client using a service 401 may include detecting a service address resolution request sent by the client. In other implementations, detecting a client using a service 401 may include performing deep packet inspection to detect a client using a service by communicating with a server.

The example method also includes identifying a service identifier for the service 402. In some implementations, the step of identifying the service identifier 402 may include inspecting a service address resolution request. For example, the service identifier may be a service instance obtained from an mDNS query. As another example, the service identifier may be a service name or domain name parsed from the service instance. In other implementations, identifying the service identifier 402 may include obtaining the service identifier by deep packet inspection of client communications.

The example method further includes obtaining a service address for the service from a server 403. In some implementations, the step of obtaining the service address 403 may include inspecting a service address response sent by the server. In other implementations, the step of obtaining the service address from the server 403 may include inspecting a service address response sent by a domain name server with which the service providing server has registered. For example, the service address may be obtained using information from an mDNS response provided by the server in response to an mDNS query from a client. In other implementations, the step of obtaining the service address 403 may include performing deep packet inspection on packets transmitted to or received from the client while using the service.

The example method also includes obtaining a configuration for the service address using the service identifier 404. This may include translating a configuration associated with the service identifier into a configuration associated with the service address. For example, a configuration handler may match the service identifier to an entry in a configuration database. In some cases, the configuration database may have entries for service identifiers of varying specificity, such as entries for service instances, service names, domain names, port numbers, and transport type. The entries may comprise configuration information associated with service identifiers. For example, the entries may have a format as illustrated in Table 1. The service identifier may be matched against the most specific applicable entry in a configuration database. After retrieving a matching entry from the configuration database, the configuration handler may generate a configuration associated with the service address obtained in step 403. For example, the configuration handler may generate a packet handling rule specifying that packets addressed to the service address should be handled in accordance with the configuration matching the service identifier. As another example, the configuration handler may generate a configuration instruction in accordance with a network node's configuration programming interface. In this example, the configuration instruction may include the service address and configuration as parameters. As a further example, the configuration handler may generate a configuration file for a network node including the configuration for the service address.

The example method further includes providing the configuration to a network node connected to the client 405. For example, the configuration may be provided to the network node as a packet handling rule. For example, the packet handling rule may be providing in accordance with a software defined networking (SDN) protocol, such as an OPENFLOW protocol. As another example, the configuration may be uploaded to the network node in accordance with a configuration interface provided by the network node. For example, the configuration may be uploaded as a configuration instruction or as a configuration file. The configuration may be provided to the network node in various manners. For example, the configuration may be provided in-band or out-of-band to an external network node. As another example, the step of providing the configuration 405 may include directly accessing an internal network node's configuration settings.

In further implementations, the steps of obtaining the configuration 404 and providing the configuration 405 may be repeated for multiple network nodes. For example, different network nodes on the path between the client and the service may be provided the same or different configurations.

In some implementations, configurations associated with service identifiers may be obtained from a network administrator. FIG. 5 illustrates an example method of obtaining a service configuration associated with a service identifier. In some cases, the illustrated method may be performed in conjunction with the method illustrated in FIG. 4. For example, a network controller may perform the method illustrated in FIG. 5 to obtain the configuration that is used in step 404 of FIG. 4.

The example method includes discovering services on a network 501. For example, a network controller may monitor network communications to discover services.

The method further includes presenting a list of identifiers of discovered services to a network administrator 502. For example, a network controller may present the list of identifiers 502 using a user interface. In some implementations, the presented list of discovered service identifiers may be discovered service instances. In further implementations, the presented list may be service names, domain names, or other service identifiers parsed from discovered service instances.

The method further includes obtaining a configuration list from the network administrator 503. In some cases, the configuration list may be a list of configurations associated with the service identifiers presented in step 502. Additionally, the configuration list may be a list of configurations associated with service identifiers generalized from the presented service identifiers. For example, if a service instance is presented in step 502, a configuration associated with the service name of the service instance may be obtained in step 503. In further cases, the configuration list may be a list of configurations associated with services not currently present on the network. For example, the network administrator may anticipate certain services becoming available on the network, and may pre-provide configurations for such services. The list obtained in step 503 may be used in step 404 to obtain configurations for network nodes. For example, the list may be used to generate a configuration database accessed as the step of obtaining the configuration 404.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A network controller, comprising:
a monitor to monitor a service address resolution message exchange to determine a service address and a service identifier for a service; and
a configuration handler to use the service identifier to obtain a configuration for the service address and provide the configuration to a network node connected to the client.

2. The network controller of claim 1, wherein the monitor is to detect:
a service address resolution request including the service identifier; and
a service address resolution response including the service address.

3. The network controller of claim 1, wherein:
the monitor is to detect the service being unavailable; and
the configuration handler is to cause the network node to remove the configuration if the service becomes unavailable.

4. The network controller of claim 1, further comprising:
a management interface to obtain the configuration associated with the service identifier and to provide the configuration to the configuration handler.

5. The network controller of claim 4, wherein:
the management interface is to obtain the configuration prior to the service becoming available.

6. The network controller of claim 4, further comprising:
a service discoverer to discover the service identifier and provide the service identifier to the management interface.

7. A non-transitory computer readable medium storing computer executable instructions executable by a processor to:
implement a monitor by monitoring a service address resolution message exchange to obtain a service identifier and a service address associated with the service identifier; and
implement a configuration handler by obtaining a configuration for a network node using the service identifier and causing the configuration to be provided to a network node.

8. The non-transitory computer readable medium 7, further having a stored configuration database, and wherein the instructions are executable by the processor to implement the configuration handler by obtaining the configuration from the configuration database.

9. The non-transitory computer readable medium 8, wherein the instructions are executable by the processor to implement the configuration handler by obtaining the configuration by matching the service identifier with a configuration database entry having a wildcard.

10. The non-transitory computer readable medium 8, wherein the instructions are executable by the processor to implement a management interface to obtain the configuration and to add the configuration to the configuration database.

11. A method, comprising:
detecting a client using a service by monitoring a service address resolution message;
identifying a service identifier for the service from the service address resolution message;
obtaining a service address for the service from a server;
obtaining a configuration for the service address using the service identifier; and
providing the configuration to a network node connected to the client.

12. The method of claim 11, wherein:
detecting the client using the service comprises monitoring a service address resolution request sent by the client; and
identifying the service identifier comprises inspecting the service address resolution request.

13. The method of claim 11, wherein obtaining a service address for the service comprises inspecting a service address response.

14. The method of claim 11, wherein obtaining the configuration comprises obtaining configuration information associated with the service identifier and associating the configuration information with the service address.

15. The method of claim 11, further comprising presenting a list of identifiers of discovered services on a network to a network administrator.
